(19) United States
(12) Patent Application Publication
(10) Pub. No.: US 2026/0014792 A1
(43) Pub. Date: Jan. 15, 2026

(54) Method for calculating the parameters for the pre-inking of a printing unit of an offset printing press with a spot colour

(71) Applicant: Hubergroup Deutschland GmbH, Kirchheim-Heimstetten (DE)

(72) Inventors: Sönke Padberg, Finning (DE); Matthias Otto, Volkach (DE)

(73) Assignee: Hubergroup Deutschland GmbH, Kirchheim-Heimstetten (DE)

(21) Appl. No.: 18/992,860

(22) PCT Filed: Jul. 26, 2023
(86) PCT No.: PCT/EP2023/070680

§ 371 Date: Jan. 9, 2025

(30) Foreign Application Priority Data
Jul. 27, 2022 (EP) 22187333.4

(51) Int. Cl. B41F 31/18; B41F 13/193; B41F 23/02; B41F 31/08; B41F 31/10; B41F 31/15; B41F 33/00

(52) U.S. Cl. CPC B41F 31/18; B41F 13/193; B41F 23/02; B41F 31/08; B41F 31/10; B41F 31/15; B41F 33/0045

(57) ABSTRACT

The present invention relates to a method for calculating the parameters for the pre-inking of a printing unit of an offset printing press with a spot colour comprising the following steps: a) predetermining a printing unit, a spot colour, a substrate to be printed with the spot colour and a specific ink coverage necessary to achieve predetermined colour coordinates of the spot colour to be achieved on the substrate, b) determining the number of vibrator roller contacts to the ink duct roller being necessary to obtain, by printing the predetermined spot colour with the predetermined printing unit onto the predetermined substrate, the specific ink coverage having been predetermined in step a) from at least two different reference spot colours, wherein each of the at least two different reference spot colours has been printed with the printing unit having been predetermined in step a) onto the substrate having been predetermined in step a) with a different predetermined specific ink coverage.

The present invention relates to a method for calculating the parameters for the pre-inking of a printing unit of an offset printing press with a spot colour.

Printing units of offset printing presses comprise a plurality of rollers, which transfers the colour to be printed onto a substrate from an ink fountain to a surface of the substrate. More specifically, the ink fountain comprises an ink key opening, through which the printing ink included in the ink fountain is transferred to the first of the plurality of the rollers, namely to the ink duct roller. Via a gap of the ink key opening (which is the gap between the ink key opening or a zone of the ink key opening, respectively, and the closest surface of the ink duct roller, the amount of printing ink per time period leaving the ink fountain can be controlled. A vibrator roller periodically jumps back and forth between the ink duct roller and another roller and transfers the printing ink from the ink duct roller to the other roller, such as a friction cylinder. The frequency, with which the vibrator roller periodically jumps back and forth between the two rollers, i.e. the number of vibrator roller contacts to the ink duct roller within a time period, controls the amount of printing ink transferred from the ink duct roller via all of the downstream rollers to the surface of the substrate. The total (surface) area of all rollers included in the printing unit can amount to several square meters, such as about 10 square meters or even more.

Before the first use of an offset printing press or after cleaning of the printing press between two different printing jobs, the rollers of the printing unit need to be appropriately wetted within a so-called pre-inking process with the printing ink so that on each part of the substrate surface the desired amount of printing ink per area, which is denoted as specific ink coverage, is obtained. Since the colour strength or colour coordinates of a colour, more or less depend on the specific ink coverage, it is essential for the quality of the printing result that on each part of the substrate surface the desired amount of printing ink per area is obtained. This is in particular due for spot colours, i. e. colours printed from a unique colour recipe including the pigment(s) in the concentrations necessary to achieve the intended colour coordinates, if the spot colours are printed with a defined specific ink coverage on the substrate. Such spot colours are used for instance in packaging and commercial printing. For spot colours, a particular exact specific coverage of the printing ink on the substrate needs to be obtained, in order to achieve the predetermined colour coordinates, because spot colours have only a small tolerance for the specific ink coverage on the substrate. In other words, if the defined specific ink coverage of the spot colour on the substrate is slightly exceeded or if the defined specific ink coverage of the spot colour on the substrate is slightly below the defined specific ink coverage on the substrate, the spot colour on the printed substrate does not have the desired colour coordinates. However, it needs quite a long time, namely up to 100 roller rotations, until the printing ink is appropriately and in the correct thickness distributed over the (surface) areas of the rollers. During this time a significant amount of printed substrate is obtained as waste. Moreover, the longer the pre-inking time is, the longer the press cannot be used for the printing job.

During the pre-inking, the press operator starts the pre-inking of the printing unit with arbitrary selected press parameters, such as an arbitrarily selected gap of the ink key opening of the ink fountain, an arbitrarily selected ink duct roller speed and/or an arbitrarily selected number of vibrator roller contacts to the ink duct roller per time period and then evaluates the obtained specific ink coverage on the substrate. If the specific ink coverage of the substrate is too high or too low, the press operator changes one or more of these selected settings so as to try to come step by step closer to the desired specific ink coverage on the substrate. This procedure is time consuming and produces a lot of printed substrate as waste. For frequently used colours, such as standard colours, such as those used in CMYK printing, the press operator has due to his experience indications, which number of vibrator roller contacts to the ink duct roller within a time period and other parameters might come at least quite close to the desired specific ink coverage on the substrate surface, this minimizing the time and amount of colour needed for the pre-inking. However, usually press operators have less or even no experience with rarely used spot colours, thus requiring more time for the pre-inking. This is particularly disadvantageous, because spot colours are usually more expensive as those used for CMYK printing. Thus, it would be desirable to have a method available, which calculates the most important parameter for the pre-inking so as to reduce the time and effort for the pre-inking of a printing unit of an offset printing press.

In view of this, the object underlying the present invention was to provide a method allowing to minimize the time required for pre-inking the printing unit of an offset printing press with a spot colour.

In accordance with the present invention, this object is satisfied by providing a method for calculating the parameters for the pre-inking of a printing unit of an offset printing press with a spot colour comprising the following steps:
a) predetermining a printing unit, a spot colour, a substrate to be printed with the spot colour and a specific ink coverage necessary to achieve predetermined colour coordinates of the spot colour to be achieved on the substrate,
b) determining the number of vibrator roller contacts to the ink duct roller being necessary to obtain, by printing the predetermined spot colour with the predetermined printing unit onto the predetermined substrate, the specific ink coverage having been predetermined in step a) from at least two different reference spot colours, wherein each of the at least two different reference spot colours has been printed with the printing unit having been predetermined in step a) onto the substrate having been predetermined in step a) with a different predetermined specific ink coverage.

This solution bases on the surprising finding that using at least two different reference spot colours and printing them, each with a different predetermined specific ink coverage, with the printing unit to be used for the printing of the spot colour onto the substrate to be used for the printing of the spot colour, allows to easily determine the number of vibrator roller contacts to the ink duct roller being necessary to obtain, by printing the predetermined spot colour with the printing unit onto the substrate, the specific ink coverage for the spot colour being necessary to achieve the predetermined colour coordinates of the spot colour. The inventors have found that there is a mathematical relationship, which is described further below, between the area to be inked, the colour strength (i.e. colour coordinates) and the required ink film thickness of the ink in the delivery form and printing unit parameters, such as ink duct roller speed, gap of ink zone opening and others. All in all, the method in accordance with the present invention allows to drastically reduce the time needed for pre-inking the printing unit of an offset printing press with a spot colour.

Specific ink coverage means in accordance with the present invention the ink coverage per area of the substrate, namely the amount of printed ink in gram per square meter of the substrate. Accordingly, ink coverage means in accordance with the present invention the amount of ink to be printed onto the area to be inked driven by the print sujet (percentage in relation to the total format which is printed) in gram, i.e. the amount of ink of the area printed on the substrate in gram.

The ink coverage may be calculated by multiplying the predetermined specific ink coverage with the total area to be inked of all rollers in the inking unit optionally together with the area of the dampening rollers, if the dampening unit is connected during the pre-inking process to the inking unit. In turn, the specific ink coverage may be measured by inking a proof roller of e.g. of the type CG1 of the company IGT Testing Systems, Almere, Netherland and measuring with a fine scale (e.g. type Series 321LT from manufacturer Precisa Gravimetrics AG, Dietikon, Switzerland) having an accuracy of measurement of at least 0,0001 g the total weight of the proof roller and of the applied ink. Afterwards, a lab print is made with the proof roller on the predetermined substrate and after the lab print the weight of the proof roller is measured with the fine scale. The difference between the total weight of the proof roller and of the applied ink before the lab print and the weight of the proof roller after the lab print is the amount of ink being transferred to the substrate in gram. This amount is divided by the printed area in cm² so as to obtain the amount of transferred ink per 1 cm², wherein this numeric value is multiplied by 10,000 so as to obtain the amount of transferred ink per square meter.

Moreover, colour coordinates mean in accordance with the present invention the position of the colour in a colour space, such as the L-, a- and b-values of the Lab-colour space, the R-, G- and B values in the RGB-colour space or the like. Usual reference standards are the CIELAB or CIEXYZ colour spaces which were specifically designed to encompass all colours the average human can see.

As set out above, the number of vibrator roller contacts to the ink duct roller being necessary to obtain, by printing the predetermined spot colour with the predetermined printing unit onto the predetermined substrate, the specific ink coverage having been predetermined in step a) is determined in accordance with the present invention from at least two different reference spot colours, wherein each of the at least two different reference spot colours has been printed with the printing unit having been predetermined in step a) onto the substrate having been predetermined in step a) with a different predetermined specific ink coverage. In tendency, the larger the differences of the different predetermined specific ink coverages of the at least two different reference spot colours, the better. Good results are for instance obtained, when in step b) the difference between the predetermined specific ink coverage on one of the at least two different reference spot colours on the substrate and the predetermined specific ink coverage on another one of the at least two different reference spot colours on the substrate is at least 0.3 g/m², more preferably at least 0.5 g/m², even more preferably at least 0.7 g/m², still more preferably at least 0.8 g/m², yet more preferably at least 1.0 g/m² and most preferably at least 1.2 g/m² of the substrate. The upper limit of the difference between the predetermined specific ink coverage on one of the at least two different reference spot colours on the substrate and the predetermined specific ink coverage on another one of the at least two different reference spot colours on the substrate is preferably 3.0 g/m², so that the preferred difference between the predetermined specific ink coverage on one of the at least two different reference spot colours on the substrate and the predetermined specific ink coverage on another one of the at least two different reference spot colours on the substrate is 0.3 to 3.0 g/m², more preferably 0.5 to 2.0 g/m², even more preferably 0.7 to 2.0 g/m², still more preferably 0.8 to 2.0 g/m², yet more preferably 1.0 to 2.0 g/m² and most preferably 1.2 to 2.0 g/m² of the substrate. Thus, in case of exactly two different reference spot colours being used in step b), it is preferred that both different reference spot colours differ from each other as described above. If more than two different reference spot colours are used in step b), it is preferred that the predetermined specific ink coverage on one of the at least two different reference spot colours on the substrate differs from the predetermined specific ink coverage on another one of the at least two different reference spot colours on the substrate by at least 0.3 g/m², preferably at least 0.5 g/m², more preferably at least 0.7 g/m², even more preferably at least 0.8 g/m², still more preferably at least 1.0 g/m² and most preferably at least 1.2 g/m², such as by 0.3 to 3.0 g/m², more preferably 0.5 to 2.0 g/m², even more preferably 0.7 to 2.0 g/m², still more preferably 0.8 to 2.0 g/m², yet more preferably 1.0 to 2.0 g/m² and most preferably 1.2 to 2.0 g/m² of the substrate, wherein the rest of the more than two different reference spot colours may or may not differ from each other by the aforementioned values. More preferably, each of the different reference spot colours is printed onto the substrate with specific ink coverages differing concerning its specific ink coverage from all others of the different reference spot colours by at least 0.3 g/m², more preferably by at least 0.5 g/m², even more preferably by at least 0.7 g/m², still more preferably by at least 0.8 g/m², yet more preferably by at least 1.0 g/m² and most preferably by at least 1.2 g/m², such as by 0.3 to 3.0 g/m², more preferably 0.5 to 2.0 g/m², even more preferably 0.7 to 2.0 g/m², still more preferably 0.8 to 2.0 g/m², yet more preferably 1.0 to 2.0 g/m² and most preferably 1.2 to 2.0 g/m² of the substrate.

The method in accordance with the present invention is not particularly limited concerning the number of different reference spot colours used in step b). In tendency, the more different reference spot colours are used in step b), the more precise results may be expected, but the more experimental effort is needed. In view of this, it is preferred that in step b) two to ten, more preferably two to five, even more preferably two to four and still more preferably two or three different reference spot colours are used. However, it has been shown during the development of the present invention that already the use of two different reference spot colours is sufficient to reliably determine the number of vibrator roller contacts to the ink duct roller being necessary to obtain, by printing the predetermined spot colour with the predetermined printing unit onto the predetermined substrate, the specific ink coverage having been predetermined in step a). Accordingly, it is most preferred that in step b) exactly two different reference spot colours are used.

In addition, it is preferred that different reference colours used belong to the same colour series as the spot colour used in the subsequent process, i.e. that the reference colours are based on the same binders and solvents as well as to the same drying mechanism.

In accordance with the present invention in step b) at least two different reference spot colours are used. However, the present invention is not restricted concerning the kind of difference of the at least two different reference spot colours. For instance, the at least two different reference spot colours may differ concerning the kind of pigment(s) included in the respective spot colours, but may have the same concentration of pigment(s). Alternatively, the at least two different reference spot colours may contain the same kind of pigment(s), but may differ concerning the concentration(s) of the pigment(s). Still alternatively, the at least two different reference spot colours may differ concerning the kind of pigment(s) included in the respective spot colours and differ concerning the concentration(s) of the pigment(s).

In view of this, according to a preferred embodiment of the present invention, at least one of the at least two different reference spot colours used in step b) has different colour coordinates than at least one other of the at least two different reference spot colours. In this embodiment it is further preferred that in case of more than two different reference spot colours being used in step b), each of the different reference spot colours has different colour coordinates than all other of the different reference spot colours. This may be easily realized by including in at least one of the at least two different reference spot colours used in step b) at least one pigment being different from pigment(s) being contained in the one or more others of the at least two different reference spot colours.

In accordance with an alternative preferred embodiment of the present invention, at least one of the at least two different reference spot colours used in step b) has the same colour coordinates as at least one other of the at least two different reference spot colours. If more than two different reference spot colours are used in step b), it is preferred, but not mandatory, that all of the different reference spot colours have the same colour coordinates. This may be easily realized by including the same pigment(s) into the concerned reference spot colours, but in a different concentration so as to fulfil the requirement of being different reference spot colours.

In accordance with the present invention, the printing unit predetermined in step a) is an offset printing unit and preferably a sheetfed offset printing unit or a rotary web offset printing unit.

In a further development of the idea of the present invention it is suggested that the printing unit predetermined in step a) comprises an inking unit, a fountain unit, a plate cylinder, a blanket cylinder and an impression cylinder, wherein the inking unit preferably comprises an ink fountain, a vibrator roller, an ink duct roller and one or more ink rollers.

In accordance with the present invention, the number of vibrator roller contacts to the ink duct roller being necessary to obtain, by printing the predetermined spot colour with the predetermined printing unit onto the predetermined substrate, the specific ink coverage having been predetermined in step a) is determined in step b) from at least two different reference spot colours, wherein each of the at least two different reference spot colours has been printed with the printing unit having been predetermined in step a) onto the substrate having been predetermined in step a) with a different predetermined specific ink coverage. Preferably, the determination in step b) considers in addition to the different specific ink coverages of the at least two different reference spot colours also further parameters.

More specifically, it is preferred in a first aspect of the present invention that the determination in step b) of the number of vibrator roller contacts to the ink duct roller being necessary to obtain, by printing the predetermined spot colour with the predetermined printing unit onto the predetermined substrate, the specific ink coverage having been predetermined in step a) comprises for each of the at least two different reference spot colours the consideration of:
a) the total area to be inked of all rollers in the inking unit optionally together with the area of the dampening rollers, if the dampening unit is connected during the pre-inking process to the inking unit,
b) the ink duct roller speed,
c) the number of vibrator roller contacts to the ink duct roller and
d) the gap of the ink key opening of the ink fountain.

The consideration of any of the aforementioned parameters during the determination of step b) means that any of the aforementioned parameters being adjusted during the printing of the at least two different reference spot colours is used for determination of the number of vibrator roller contacts to the ink duct roller being necessary to obtain, by printing the predetermined spot colour with the predetermined printing unit onto the predetermined substrate, the specific ink coverage having been predetermined in step a).

Moreover, it is preferred that each of the at least two different reference spot colours has not only been printed with the printing unit having been predetermined in step a) onto the substrate having been predetermined in step a) with a different predetermined specific ink coverage, but also with at least one further different or same parameter, such as a different or the same predetermined ink duct roller speed and/or with a different or the same predetermined gap of ink key opening of the ink fountain. Thus, preferably, the number of vibrator roller contacts to the ink duct roller being necessary to obtain, by printing the spot colour with the printing unit onto the substrate, the specific ink coverage having been predetermined in step a) is determined in step b) from at least two different reference spot colours and preferably from two different reference spot colours each of which having been printed with the printing unit having been predetermined in step a) onto the substrate having been predetermined in step a) i) with a different predetermined specific ink coverage and ii) with a different or preferably the same predetermined ink duct roller speed and/or iii) with a different or preferably the same predetermined gap of ink key opening of the ink fountain.

In accordance with a particular preferred embodiment of the present invention, each of the at least two different reference spot colours has not only been printed with the printing unit having been predetermined in step a) onto the substrate having been predetermined in step a) with a different predetermined specific ink coverage, but also with the same predetermined ink duct roller speed as well as with the same predetermined gap of ink key opening of the ink fountain. Thus, it is preferred that the number of vibrator roller contacts to the ink duct roller being necessary to obtain, by printing the spot colour with the printing unit onto the substrate, the specific ink coverage having been predetermined in step a) is determined in step b) from at least two different reference spot colours and preferably from two different reference spot colours each of which having been printed with the printing unit having been predetermined in step a) onto the substrate having been predetermined in step a) i) with a different predetermined specific ink coverage, ii) with the same predetermined ink duct roller speed and iii) with the same predetermined ink key opening.

In a further development of the idea of the present invention, it is proposed that the method comprises:
i) before printing the at least two different reference spot colours with the printing unit having been predetermined in step a) onto the substrate having been predetermined in step a), predetermining for each of the at least two different reference spot colours an ink coverage being necessary to achieve a predetermined specific ink coverage to be achieved by the printing, a gap of the ink key opening of the ink fountain of the printing unit to be adjusted during the printing and an ink duct roller speed to be adjusted during the printing, wherein the specific ink coverages predetermined for each of the at least two different reference spot colours are different to each other,
ii) printing each of the at least two different reference spot colours with the predetermined ink coverage, with the predetermined gap of the ink key opening of the ink fountain of the printing unit, with the predetermined ink duct roller speed and with an arbitrarily selected number of vibrator roller contacts to the ink duct roller with the printing unit having been predetermined in step a) onto the substrate having been predetermined in step a),
iii) determining, whether the predetermined specific ink coverage has been achieved on the substrate or not, wherein, if the predetermined specific ink coverage has been achieved on the substrate, the arbitrarily selected number of vibrator roller contacts to the ink duct roller is saved as the appropriate number of vibrator roller contacts to the ink duct roller for the respective reference spot colour, and, if the predetermined specific ink coverage has not been achieved on the substrate, step ii) is repeated for the concerned reference spot colour with one or more other arbitrarily selected numbers of vibrator roller contacts to the ink duct roller so often, until the predetermined specific ink coverage is achieved on the substrate, wherein the numbers of vibrator roller contacts for achieving the predetermined specific ink coverage on the substrate is saved as the appropriate number of vibrator roller contacts to the ink duct roller, and
iv) calculating from the appropriate numbers of vibrator roller contacts to the ink duct roller, the predetermined ink coverages, the predetermined gaps of the ink key opening of the ink fountain and the predetermined ink duct roller speeds of each of the at least two reference spot colours the number of vibrator roller contacts to the ink duct roller to be used in step b) being necessary to obtain, by printing the predetermined spot colour with the predetermined printing unit onto the predetermined substrate, the specific ink coverage having been predetermined in step a) being necessary to obtain, by printing the predetermined spot colour with the predetermined printing unit onto the predetermined substrate, the specific ink coverage having been predetermined in step a).

Moreover, it is preferred that in the aforementioned step i) the ink coverage for each of the reference spot colours is calculated as product (i.e. by multiplication) of the total area to be inked of all rollers in the inking unit optionally together with the area of the dampening rollers, if the dampening unit is connected during the pre-inking process to the inking unit, and of the predetermined specific ink coverage on the reference spot colour to be achieved on the substrate.

According to a further particular preferred embodiment of the present invention, in step b) for each of the reference spot colours a coefficient is calculated according to the following formula (1):

$${K}_{n} = {M}_{n} / ( {B}_{n} \cdot {DS}_{n} \cdot NV {R}_{n} ) \qquad ( 1 )$$

wherein:
K means coefficient,
n is an integer representing the number of the reference spot colour concerned,
M is the amount of the spot colour ink in grams required for inking the total area to be inked of all rollers in the inking unit optionally together with the area of the dampening rollers, if the dampening unit is connected during the pre-inking process to the ink unit, representing the specific grammage per square meter for the respective reference colour,
B is the gap of the ink key opening used during the pre-inking process of the respective reference spot colour in m,
DS is the ink duct roller speed used during the pre-inking process of the respective reference spot colour in m/min, and
NVR is the number of vibrator roller contacts to the ink duct roller.

It is particularly preferred that the method of the aforementioned embodiment further comprises:
calculating the ink coverage of the spot colour being necessary to achieve the specific ink coverage being in turn necessary to achieve the colour coordinates of the spot colour on the substrate having been predetermined in step a) as product of the total area to be inked of all rollers in the inking unit optionally together with the area of the dampening rollers, if the dampening unit is connected during the pre-inking process to the inking unit, and of the predetermined specific ink coverage to be achieved on the substrate,
predetermining the ink duct roller speed used during the pre-inking process of the spot colour and
predetermining the gap of the ink key opening used during the pre-inking process of the spot colour,
   wherein the number of vibrator roller contacts to the ink duct roller being necessary to obtain, by printing the predetermined spot colour with the predetermined printing unit onto the predetermined substrate, the specific ink coverage having been predetermined in step a) is calculated from the predetermined ink coverage (e.g. using small scale laboratory printing machines for printing and measuring the applied amount of ink), the predetermined ink duct roller speed (preferably originating from pre-press data), the predetermined gap of the ink key opening and the coefficients Kₙ of the at least two reference spot colours.

In a further development of the idea of the aforementioned embodiment, it is suggested that two reference spot colours are used in step b) of the method, wherein the method further comprises:
v) calculating for the spot colour predetermined in step a) a coefficient K according to the formula (2):

$$K = ( {K}_{1} - {K}_{2} ) / ( {M}_{1} - {M}_{2} ) \cdot M + {K}_{1} - ( ( {K}_{1} - {K}_{2} ) / ( {M}_{1} - {M}_{2} ) ) \cdot {M}_{1} , \qquad ( 2 )$$

in which:
K is the coefficient to be calculated for the spot colour predetermined in step a),
K₁ is the coefficient having been calculated according to formula (1) for a first of the two reference spot colours,
K₂ is the coefficient having been calculated according to formula (1) for the second of the two reference spot colours,
M is the amount of the spot colour ink predetermined in step a) in grams required for inking the total area to be inked of all rollers in the inking unit optionally together with the area of the dampening rollers, if the dampening unit is connected during the pre-inking process to the ink unit,
M₁ is the amount of the first reference spot colour ink in grams required for inking the total area to be inked of all rollers in the inking unit optionally together with the area of the dampening rollers, if the dampening unit is connected during the pre-inking process to the rollers of the ink unit and
M₂ is the amount of the second reference spot colour ink in grams required for inking the total area to be inked of all rollers in the ink unit optionally together with the area of the dampening rollers, if the dampening unit is connected during the pre-inking process to the ink unit,
and
vi) calculating the number of vibrator roller contacts to the ink duct roller being necessary to obtain for the spot colour predetermined in step a) the specified colour coordinates by printing the spot colour with the inking unit onto the substrate in the specific ink coverage having been predetermined in step a) according to the formula (3):

$$NVR = M / ( K \cdot DS \cdot B ) , \qquad ( 3 )$$

wherein:
NVR is the number of vibrator roller contacts to the ink duct roller being necessary to obtain for the spot colour predetermined in step a) the specified colour coordinates by printing the spot colour with the inking unit onto the substrate in the specific ink coverage having been predetermined in step a),
M is as defined above with regard to formula (2),
K is the coefficient having been calculated in step v) with formula (2),
DS is the ink duct roller speed in m/minute and
B is the gap of the ink key opening used during the pre-inking process of the spot colour in m.

In accordance with an alternative particular preferred embodiment of the present invention, the number of vibrator roller contacts to the ink duct roller being necessary to obtain, by printing the predetermined spot colour with the predetermined printing unit onto the predetermined substrate, the specific ink coverage having been predetermined in step a) is not determined by calculating and using the aforementioned coefficients, but by using a polynomial trend line of the specific ink coverage of each of the reference spot colours versus the appropriate number of vibrator roller contacts to the ink duct roller of each of the reference spot colours having been determined in the aforementioned step iii). More specifically, in this embodiment a polynomial trend line of the specific ink coverage of each of the reference spot colours versus the appropriate number of vibrator roller contacts to the ink duct roller of each of the reference spot colours having been determined in the aforementioned step iii) is determined, wherein the number of vibrator roller contacts to the ink duct roller being necessary to obtain, by printing the predetermined spot colour with the predetermined printing unit onto the predetermined substrate, the specific ink coverage having been predetermined in step a) is determined from the polynomial trend line. For instance, the specific ink coverage of each of the reference spot colours is plotted in a graph at the ordinate, whereas the appropriate number of vibrator roller contacts to the ink duct roller of each of the reference spot colour having been determined in the aforementioned step iii) is plotted at the abscissa of the graph, before the polynomial trend line is determined by using the method of least squares.

The present invention is not particularly limited concerning the order of the polynomial trend line. Good results are, however, achieved, when the polynomial trend line is of order 2 to 5 and more preferably of order 2 to 4. Again, it is preferred that the polynomial trend line is determined by using the method of least squares.

In a further development of the idea of the present invention, it is suggested that three to twenty, more preferably five to twenty and most preferably eight to twelve reference spot colours are used for determining the polynomial trend line.

Furthermore, it is preferred that the predetermined specific ink coverages of all reference spot colours cover at least a numeric value range of 1.2 to 1.6 g/m², more preferably of 1.0 to 1.8 g/m² and most preferably of 0.8 to 2.0 g/m².

In accordance with a second aspect of the present invention, the determination in step b) of the number of vibrator roller contacts to the ink duct roller being necessary to obtain, by printing the predetermined spot colour with the predetermined printing unit onto the predetermined substrate, the specific ink coverage having been predetermined in step a) comprises for each of the at least two different reference spot colours the consideration of:
a) the total area to be inked of all rollers in the inking unit optionally together with the area of the dampening rollers, if a dampening unit is connected during the pre-inking to the inking unit,
b) the ink film thickness on the vibrator roller,
c) the contact length between the duct roller and the vibrator roller,
d) the physical density of the spot colour and
d) the ink fountain width.

The consideration of any of the aforementioned parameters during the determination of step b) means that any of the aforementioned parameters being adjusted and measured during the printing of the at least two different reference spot colours is used for determination of the number of vibrator roller contacts to the ink duct roller being necessary to obtain, by printing the predetermined spot colour with the predetermined printing unit onto the predetermined substrate, the specific ink coverage having been predetermined in step a).

Preferably, the number of vibrator roller contacts to the ink duct roller being necessary to obtain, by printing the spot colour with the printing unit onto the substrate, the specific ink coverage having been predetermined in step a) is determined in step b) from at least two different reference spot colours and preferably from at least three different reference spot colours each of which having been printed with the printing unit having been predetermined in step a) onto the substrate having been predetermined in step a) i) with a different predetermined specific ink coverage and ii) with a different or preferably the same predetermined ink film thickness on the vibrator roller and/or iii) with a different or preferably the same predetermined contact length between the duct roller and the vibrator roller and/or iii) with a different or preferably the same predetermined ink fountain width.

In a further development of the idea of the present invention, it is suggested that the method comprises:
i) before printing the at least two different reference spot colours with the printing unit having been predetermined in step a) onto the substrate having been predetermined in step a), predetermining for each of the at least two different reference spot colours an ink coverage being necessary to achieve a predetermined specific ink coverage to be achieved by the printing, a contact length between the duct roller and the vibrator roller to be adjusted during the printing, an ink film thickness on the vibrator roller to be adjusted during the printing and an ink fountain width to be adjusted during the printing, wherein the specific ink coverages predetermined for each of the at least two different reference spot colours are different to each other,
ii) calculating for each of the at least two different reference spot colours the number of vibrator roller contacts to the ink duct roller being required to ink the whole area of the printing unit,
iii) printing each of the at least two different reference spot colours with the predetermined ink coverage, with the predetermined contact length between the duct roller and the vibrator roller, with the predetermined ink film thickness on the vibrator roller, with the predetermined ink fountain width and with an arbitrarily selected number of vibrator roller contacts to the ink duct roller with the printing unit having been predetermined in step a) onto the substrate having been predetermined in step a),
iv) determining, whether the predetermined specific ink coverage has been achieved on the substrate or not, wherein, if the predetermined specific ink coverage has been achieved on the substrate, the arbitrarily selected number of vibrator roller contacts to the ink duct roller is saved as the appropriate number of vibrator roller contacts to the ink duct roller for the respective reference spot colour, and, if the predetermined specific ink coverage has not been achieved on the substrate, step ii) is repeated for the concerned reference spot colour with one or more other arbitrarily selected numbers of vibrator roller contacts to the ink duct roller so often, until the predetermined specific ink coverage is achieved on the substrate, wherein the numbers of vibrator roller contact being for achieving the predetermined specific ink coverage on the substrate is saved as the appropriate number of vibrator roller contacts to the ink duct roller,
v) determining a polynomial trend line of the appropriate number of vibrator roller contacts to the ink duct roller having been determined in step iv) for the at least two different reference spot colours versus the number of vibrator roller contacts to the ink duct roller having been calculated in step ii) preferably by using the method of least squares, and
vi) calculating for the spot colour having been predetermined in step a) the number of vibrator roller contacts to the ink duct roller being required to ink the whole area of the printing unit and calculating therefrom using the polynomial trend line having been predetermined in step v) the number of vibrator roller contacts to the ink duct roller being necessary to obtain, by printing the predetermined spot colour with the predetermined printing unit onto the predetermined substrate, the specific ink coverage having been predetermined in step a).

The calculation for each of the at least two different reference spot colours the number of vibrator roller contacts to the ink duct roller being required to ink the whole area of the printing unit of step ii) may be done as follows. The required volume (V) of the respective reference spot colour to achieve an accurate ink saturation so as to achieve the colour target is calculated, for instance by multiplying the total area to be inked of all rollers in the inking unit of the printing press (without the area of the dampening rollers, since the dampening unit was not connected during the pre-inking process to the inking unit) with the specific ink coverage predetermined for the respective reference spot colour. In addition, the amount (A) of the respective reference spot colour, which is transferred during one ink duct roller and vibrator roller contact, is calculated, for instance by multiplying the predetermined contact length between the duct roller and the vibrator roller with the predetermined ink film thickness on the vibrator roller and with the predetermined ink fountain width and with the physical density of the respective reference spot colour. The number of vibrator roller contacts to the ink duct roller being required to ink the whole area of the printing unit of step ii) may then be easily calculated by dividing the above mentioned volume (V) by the amount (A).

Since the ink transfer between the individual rollers in the inking unit is usually not the theoretical possible, but in practice less, it is preferable to determine a correction factor, which considers the difference between the theoretically achievable and the practical achieved amount of ink transfer between the rollers in the printing unit, and to use this correction factor for determining form the above calculated number number of vibrator roller contacts to the ink duct roller being required to ink the whole area of the printing unit of step ii) the actual number number of vibrator roller contacts to the ink duct roller being necessary. Preferably, as correction factor a polynomial trend line of the specific ink coverage of each of the reference spot colours versus the appropriate number of vibrator roller contacts to the ink duct roller of each of the reference spot colours is determined, as in more detail exemplified in the subsequent example 3. Then, the number of vibrator roller contacts to the ink duct roller being necessary to obtain, by printing the predetermined spot colour with the predetermined printing unit onto the predetermined substrate, the specific ink coverage having been predetermined in step a) may be easily determined from the polynomial trend line. Namely, the theoretical number of vibrator roller contacts to the ink duct roller being required to ink the whole area of the printing unit of step ii) may be calculated for the predetermined spot colour as described above for the reference spot colours, before from this theoretical number of vibrator roller contacts to the ink duct roller the number of vibrator roller contacts to the ink duct roller being necessary to obtain, by printing the predetermined spot colour with the predetermined printing unit onto the predetermined substrate, the specific ink coverage having been predetermined in step a) is determined by using the polynomial trend line.

Good results are in particular obtained, when the polynomial trend line is determined using the method of least squares, wherein the polynomial trend line is preferably of order 2 to 5 and more preferably of order 2 to 4.

In accordance with a further preferred embodiment of the present invention, in the aforementioned embodiment three to twenty, more preferably five to twenty and most preferably eight to twelve reference spot colours are used for determining the polynomial trend line, wherein preferably the predetermined specific ink coverages of all reference spot colours cover at least a numeric value range of 1.2 to 1.6 g/m², more preferably of 1.0 to 1.8 g/m² and most preferably of 0.8 to 2.0 g/m².

Other ink-related, measurable variables that may have an influence on the pre-inking process, and therefore might be used in the calculation, are the L-value of the ink (light/dark), rheological parameters, such as tack and viscosity, the proportion of non-colouring components in the ink (transparent white), pigment type and quantity.

Measurable press-related parameters are the temperature in the printing unit—which influences rheological properties and transfer behavior of the ink from roller to roller in the printing unit —, the contact length between the duct roller and the vibrator roller during one contact, the size of gaps between the individual rollers in the printing unit, the ink fountain width, different or equal opening of the individual zones in the ink fountain and the like. These parameters might also be used in the calculation.

Furthermore, substrate-related properties, such as absorbency, surface smoothness and texture, the substrate whiteness or opacity, and the surface energy may influence the exact achievement of the colour targets. If the substrates are grouped together, for example coated paper, uncoated paper, recycled paper etc., and a calculator is generated for each group and ink type, the influence of the substrate may be accounted for.

Other press-related parameters that are difficult or impossible to measure are roller adjustment, the maintenance condition of the printing unit, roller planarity, roller types, the condition and quality of the polymeric roller coatings as well as the type and quality of the printing plates used.

Even if the pre-inking process is generally run without dampening solution, the emulsification behavior of the ink may have an influence on the ink colour shade or ink density obtained after printing. The amount of dampening solution and its composition may therefore also influence the print result.

Above three specific embodiments have been described for determining the number of vibrator roller contacts to the ink duct roller being necessary to obtain, by printing the predetermined spot colour with the predetermined printing unit onto the predetermined substrate, the specific ink coverage having been predetermined in step a). In one embodiment, parameters, such as the ink duct roller speed, the number of vibrator roller contacts to the ink duct roller and the gap of the ink key opening of the ink fountain, are predetermined for the reference spot colours and coefficients are determined from which the number of vibrator roller contacts to the ink duct roller being necessary to obtain, by printing the predetermined spot colour with the predetermined printing unit onto the predetermined substrate, the specific ink coverage having been predetermined in step a) is calculated. In another embodiment, parameters, such as the ink duct roller speed, the number of vibrator roller contacts to the ink duct roller and the gap of the ink key opening of the ink fountain, are predetermined for the reference spot colours and the number of vibrator roller contacts to the ink duct roller being necessary to obtain, by printing the predetermined spot colour with the predetermined printing unit onto the predetermined substrate, the specific ink coverage having been predetermined in step a) is calculated using a polynomial trend line of the specific ink coverage of each of the reference spot colours versus the appropriate number of vibrator roller contacts to the ink duct roller of each of the reference spot colours. In still another embodiment, other parameters, such as the ink film thickness on the vibrator roller, the contact length between the duct roller and the vibrator roller, the physical density of the spot colour and the ink fountain width, are predetermined for the reference spot colours and the number of vibrator roller contacts to the ink duct roller being necessary to obtain, by printing the predetermined spot colour with the predetermined printing unit onto the predetermined substrate, the specific ink coverage having been predetermined in step a) is calculated using a polynomial trend line of the appropriate number of vibrator roller contacts to the ink duct roller from print trials versus the calculated number of vibrator roller contacts to the ink duct roller. A calculator may be programmed to automatically perform the respective calculations described above. Moreover, it is possible to connect this calculator directly or via an interface with the control system of the printing press. The calculator may also be linked to a prepress process, in which the respective parameters, such as printing plates and the ink duct roller speed, are calculated, possibly as a link to the press control system. Still alternatively, the calculator may, for example, be linked analogue or digitally, directly or via an interface with ink formulation software or systems for digital colour communication (HDCC of hubergroup Germany GmbH), in which the specific ink coverage of the commercial printing inks is already recorded or that of newly generated printing inks is also recorded. Furthermore, the calculator may also be linked to other databases, such as SAP, from which ink-specific data required for calculating the vibration roller contacts can also be accessed. The calculator may be expanded as a universal calculator by taking into account other influencing variables such as substrate types, dampening solution types, press types and ink series. The system for optimising the ink feed may use mobile devices, be linked to a database, be set up as an app, and be usable via various terminals. The calculator may have a control step built in if calculated duct or vibrator roller contacts do not produce the desired print result. This may serve as a tool for early detection of maintenance needs or adjustment problems.

The present invention is not particularly limited concerning the kind of substrate. Good results are in particular obtained, when the substrate predetermined in step a) is a foil, a film, a coated or uncoated paper, a metal substrate, a metallized substrate, a laminate or a cardboard.

The present invention is also particularly suitable for physically and/or chemically drying offset inks, or inks with combined drying mechanisms, e.g. permeation drying offset spot colour inks, evaporation drying offset spot colour inks, oxidatively drying offset spot colour inks as well as for radiation-curing offset spot colour inks, radically curing and/or cationically curing and/or additional NCO/OH curing reactions, and inks with combined drying mechanisms.

Subsequently, the present invention is described by means of an illustrating, but not limiting figure.

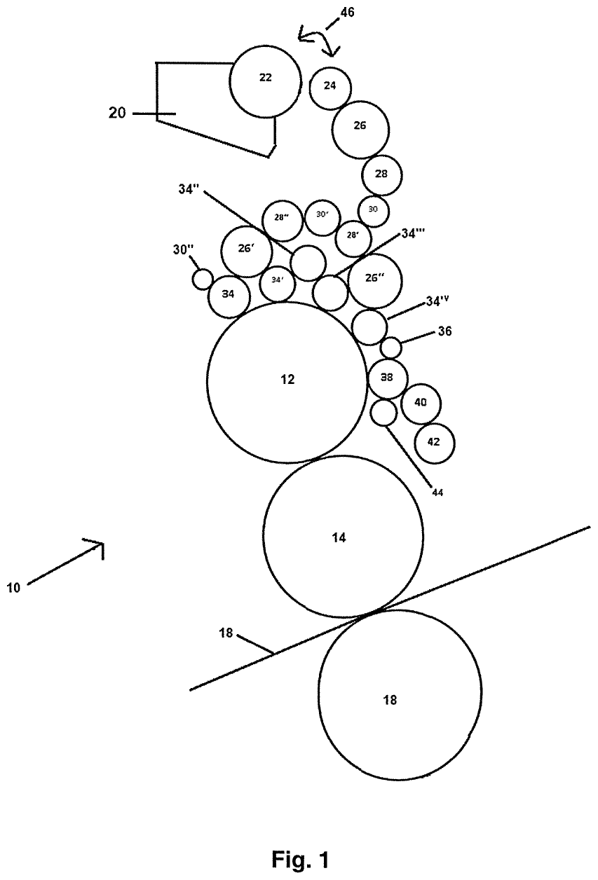

FIG. 1 shows schematically a printing unit of an offset printing press being suitable to be used in the method of the present invention.

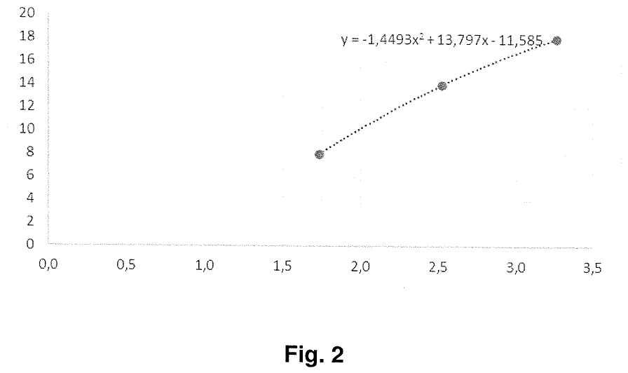

FIG. 2 shows the polynomial trend line of order 2 of the numbers of vibrator roller contacts to the ink duct roller of each of the reference spot colours 1 to 3 having been determined in the respective printing experiments described in example 3 versus the calculated numbers of vibrator roller contacts to the ink duct roller of each of the reference spot colours 1 to 3 on the abscissa.

The printing unit 10 of an offset printing press being suitable to be used in the method of the present invention shown as schematic side view comprises a plate cylinder 12, a blanket cylinder 14 and an impression cylinder 16, wherein between the blanket cylinder 14 and the impression cylinder 16 a substrate 18 to be printed with the spot colour is led through. The printing ink is transferred during the pre-inking process and the later printing process from the plate cylinder 12 to the blanket cylinder 14 and further onto one surface of the substrate 18, whereas the impression cylinder 16 functions as counterpressure cylinder. Moreover, the printing unit comprises an ink fountain 20, an ink duct roller 22, a vibrator roller 24 and further rollers, through which the printing ink is transferred during the pre-inking process and the later printing process from the ink fountain 20 via the ink duct roller 22, then via the vibrator roller 24 and then via the further rollers onto the blanket cylinder 14 and from there onto the surface of the substrate 18. The ink fountain 20 includes an ink key opening (not shown) with variable adjustable gap through which the ink is transferred onto the surface of the ink duct roller, through which the amount of printing ink transferred per time period onto the ink duct roller 20 is controlled. The further rollers are friction cylinders 26, 26′, 26″, friction rollers 28, 28′, 28″, weight rollers 30, 30′, 30″, friction cylinders 32, 32′, 32″, colour application rollers 34, 34′, 34″, 34′″, 34^{iv} as well as rollers belonging to the fountain unit, namely a fountain bridge roller 36, a fountain application roller 38, a transfer roller 40, a fountain dosing roller 42 and a rider roller 44. There is a larger gap between the ink duct roller 22 and the friction cylinder 26, so that the vibrator roller 24 does not contact simultaneously each of its neighbouring ink duct roller 22 and friction cylinder 26, but the vibrator roller 24 periodically jumps back and forth between the two elements so that the vibrator roller 24 periodically contacts either the ink duct roller 22 or the friction cylinder 26 as indicated by the arrow 46.

Subsequently, the present invention is described by means of illustrating, but not limiting examples.

### EXAMPLE 1

### (Spot Colours, Printing Press and Press Settings)

The following colours, printing press and parameters were used or adjusted, respectively:
Printing press: KBA PA 145, of the company König & Bauer AG, Radebeul, Germany.
Fount solution: Böttcher SC042-73, 4% in fully demineralised water, hardened with Böttcher magnesite, 0.7%, ready-mixed fount solution has 700 μs/cm² conductivity, a water hardness of 12° German hardness, a pH value of 5.7 at 7.5° C. and an alcohol content of 4.5%.
Total area to be inked of all rollers in the inking unit of the printing press (the area of the dampening rollers, since the dampening unit was not connected during the pre-inking process to the inking unit): 9.25 m²
Print format: 102×142 cm
Substrate: Serviliner GD2-FSC®, material thickness: 250 g/m²
Spot colour of example 1: MGA Natura 660613P, of the company hubergroup Deutschland GmbH, Celle, Germany.
Specific ink coverage of the spot colour of example 1: 1.5 g/m²
Ink duct roller speed of the spot colour of example 1: 26%

This percentage number has been calculated or generated, respectively, via the ink coverage area calculation in the prepress process. This information has been transferred to the press using e.g. cip3 data format and has been used both for the printing and for the pre-inking. Cip3 means “Cooperation for Integration of Pre-press, Press and Postpress”. This format is the current standard for transferring order related data in printing processes.
Gap of ink key opening of the ink fountain for the spot colour of example 1: 60%
Reference spot colour 1: 679540P MGA Natura Grün MOPS intense, of the company hubergroup Deutschland GmbH, Celle, Germany.
Specific ink coverage of reference spot colour 1: 1.2 g/m²
Ink duct roller speed for reference spot colour 1: 9%

This percentage number has been calculated or generated, respectively, via the ink coverage area calculation in the prepress process. This information has been transferred to the press using e.g. cip3 data format and has been used both for the printing and for the pre-inking. This format is the current standard for transferring order related data in printing process.
Gap of ink key opening of the ink fountain for reference spot colour 1: 60%
Reference spot colour 2: 679539P MGA Natura Grün MOPS low, of the company hubergroup Deutschland GmbH, Celle, Germany.
Specific ink coverage of reference spot colour 2: 1.8 g/m²
Ink duct roller speed for spot colour 2: 9% generated as described above.
Gap of ink key opening of the ink fountain for reference spot colour 2: 60%

### (Recalculation of the Ink Duct Roller Speed and the Gap of the Ink Key Opening of the Ink Fountain for Reference Spot Colours 1 and 2)

The ink duct roller speed of the printing unit of the printing press has to be adjusted in % and thus needs to be recalculated into a numeric value in m/minute. Therefore, the printing press has been operated with an ink duct roller speed of 9% (being the setting of the printing press during the pre-inking process) and the speed of the ink duct roller in m/minute has been measured with a digital hand tachometer. Thereby, the following ink duct roller speed was obtained:
Ink duct roller speed for reference spot colour 1: 2.72 m/minute
Ink duct roller speed for reference spot colour 2: 2.72 m/minute

Furthermore, the gap of the ink key opening of the ink fountain for reference spot colours 1 and 2 of 60% (being the setting of the printing press during the pre-inking process) has been determined in mm by measuring the gap of the ink key opening of the ink fountain with a feeler gauge. Thereby, the following gap of the ink key opening of the ink fountain was obtained:
Gap of ink key opening of the ink fountain for reference spot colour 1: 0.15 mm
Gap of ink key opening of the ink fountain for reference spot colour 2: 0.15 mm

### (Calculation of the Ink Coverage for Reference Spot Colours 1 and 2)

The ink coverages for reference spot colours 1 and 2 have been calculated according to the following formula:

Mₙ=F·SMₙ,
wherein:
n is an integer of 1 or 2 representing the number of the reference spot colour
Mₙ is the ink coverage of the reference spot colour,
F is the total area to be inked of all rollers in the inking unit of the printing press, i.e. 9.25 m² as set out above, and
SMₙ is the specific ink coverage of the reference spot colour, i.e. 1.2 g/m² for reference spot colour 1 and 1.8 g/m² for reference spot colour 2.

Thereby, the following ink coverages were obtained:
Ink coverage of reference spot colour 1: 11.10 g
Ink coverage of reference spot colour 2: 16.65 g

### (Determining the Numbers of Vibrator Roller Contacts to the Ink Duct Roller for Reference Spot Colours 1 and 2)

A pre-inking of the printing unit of the above-mentioned printing press onto the above-mentioned substrate has been performed in two separate sets of experiments with each of the reference spot colours 1 and 2 using the above-mentioned ink duct roller speeds and the above-mentioned gaps of ink key opening of the ink fountain. Each set of experiments was started with a number of vibrator roller contacts to the ink duct roller of 22 and after the pre-inking the obtained specific ink coverage of the respective reference spot colour on the substrate has been measured. With a number of vibrator roller contacts to the ink duct roller of 22, the obtained specific ink coverage was too high and thus in further printings for both of the reference spot colours the number of vibrator roller contacts to the ink duct roller have been reduced so long until the predetermined, above mentioned specific ink coverage was obtained, namely 1.2 g/m² for reference spot colour 1 and 1.8 g/m² for reference spot colour 2. Thereby, the following numbers of vibrator roller contacts to the ink duct roller were obtained:
Numbers of vibrator roller contacts to the ink duct roller for reference spot colour 1: 19
Numbers of vibrator roller contacts to the ink duct roller for reference spot colour 1: 16

### (Calculating the Coefficients for Reference Spot Colours 1 and 2)

With the above-mentioned parameters, the coefficients for reference spot colours 1 and 2 were calculated using formula (1).

$$K 1 = 11.1 g / ( 1.5 \cdot {10}^{- 4} m \cdot 2.72 m / min \cdot 19 ) = 1432 ( g \cdot {m}^{2} ) / min .$$

$$K 2 = 16.65 g / ( 1.5 {10}^{- 4} m \cdot 2.72 m / min \cdot 16 ) = 2551 ( g \cdot {m}^{2} ) / min .$$

### (Calculating the Coefficient for the Spot Colour of Example 1)

The ink duct roller speed of the spot colour of example 1 of 26% (this percentage number has been calculated/generated via the ink coverage area calculation in prepress department; this information has been transferred to the press using the cip3 data format and has been used both for printing and for pre-inking). The ink duct roller speed in m/minute has been measured with a digital hand tachometer. Thereby, the following ink duct roller speed was obtained:
Ink duct roller speed for the spot colour of example 1: 6.64 m/minute.

Using this ink duct roller speed of the spot colour of example 1, the coefficient of the spot colour of example 1 can be calculated according to formula (2) as follows:

$$K = ( {K}_{1} - {K}_{2} ) / ( {M}_{1} - {M}_{2} ) \cdot M + {K}_{1} - ( ( {K}_{1} - {K}_{2} ) / ( {M}_{1} - {M}_{2} ) ) \cdot {M}_{1} , \qquad ( 2 )$$

which is

$${K = ( 1 \; 432 - 2551 ) / {( 11 , 1 - 16 , 65 )}^{⋆} 13 , 875 + 1432 - ( ( 1 \; 432 - 2551 ) / 11 , 1 - 16 , 65 ) )}^{⋆} 11 , 1 = 1992 ( g \cdot {m}^{2} ) / min .$$

### (Calculating the Number of Vibrator Roller Contacts to the Ink Duct Roller for the Spot Colour of Example 1)

The ink coverage for the spot colour of example 1 can be calculated according to the above-mentioned formula Mₙ=F·SMₙ=9.25·1.5 g/m²=13.875 g.

Using the above calculated coefficient K=1992 (g·m²)/minute, the number of vibrator roller contacts to the ink duct roller for the spot colour of example 1 can be calculated according to formula (3) as follows:

$$NVR = M / ( K \cdot DS \cdot B ) \qquad ( 3 )$$

which is

$$NVR = 13.875 g / ( 1992 ( g \cdot min / {m}^{2} ) \cdot 6.64 m / min \cdot {1.5}^{*} {10}^{- 4} m = 7.$$

All in all, the required setting for the number of contacts of the vibrator roller, i.e. between the ink duct roller and vibrator roller, in the printing unit of the printing press is 7.

### EXAMPLE 2

The same printing press, reference spot colours, substrate and settings were used as in example 1, except for the following:
Spot colour of example 2: MGA Natura 675056P, of the company hubergroup Deutschland GmbH, Celle, Germany.
Specific ink coverage of the spot colour of example 1: 0.8 g/m²
Ink duct roller speed of the spot colour of example 1: 36%
Gap of ink key opening of the ink fountain for the spot colour of example 1: 60%

The ink duct roller speed of the spot colour of example 2 of 36% (this percentage number has been calculated or generated, respectively, via the ink coverage area calculation in the prepress process. This information has been transferred to the press using e.g. cip3 data format and has been used both for the printing and for the pre-inking) in m/minute has been measured with a digital hand tachometer. Thereby, the following ink duct roller speed was obtained:
Ink duct roller speed for the spot colour of example 2: 8.95 m/minute.

Using this ink duct roller speed of the spot colour of example 2, the coefficient of the ink duct roller speed of the spot colour of example 2 can be calculated according to formula (2) as follows:

$$K = ( {K}_{1} - {K}_{2} ) / ( {M}_{1} - {M}_{2} ) \cdot M + {K}_{1} - ( ( {K}_{1} - {K}_{2} ) / ( {M}_{1} - {M}_{2} ) ) \cdot {M}_{1} , \qquad ( 2 )$$

which is

$${K = ( 1432 - 2551 ) / {( 11.1 - 16.65 )}^{*} 7.4 + 1432 - ( ( 1432 - 2551 ) / 11.1 - 16.65 ) )}^{*} 11.1 = 686 ( g \cdot {m}^{2} ) / min .$$

The ink coverages for the spot colour of example 2 can be calculated according to the above-mentioned formula Mₙ=F·SMₙ=9.25·0.8 g/m²=7.4 g.

Using the above calculated coefficient K=686 (g·m²)/minute, the number of vibrator roller contacts to the ink duct roller for the spot colour of example 2 can be calculated according to formula (3) as follows:

$$NVR = M / ( K \cdot DS \cdot B ) \qquad ( 3 )$$

which is

$$NVR = 7.4 g / ( 686 ( g \cdot min / {m}^{2} ) \cdot 8.95 m / min \cdot {1.5}^{*} {10}^{- 4} m = 0.8 ,$$

$$rounded to 1.$$

All in all, the required setting for the number of contacts of the vibrator roller, i.e. between the ink duct roller and vibrator roller, in the printing unit of the printing press is 1.

### EXAMPLE 3

The same printing press and fount solution were used as in example 1.
Total area to be inked (F) of all rollers in the inking unit of the printing press (without the area of the dampening rollers, since the dampening unit was not connected during the pre-inking process to the inking unit): 8.89 m²
Print format: 102×142 cm
Substrate: Serviliner GD2-FSC®, material thickness: 250 g/m²

Three reference spot colours have been used.
Reference spot colour 1: VG00113293, Pantone 386C MGA Natura, of the company hubergroup Deutschland GmbH, Celle, Germany.

Specific ink coverage of reference spot colour 1 (SM₁): 0.9 g/m²
Density (ρ₁) of reference spot colour 1: 1.009 g/cm³.
Contact length (CL) between the duct roller and the vibrator roller: 4.2 cm.
Ink film thickness on the vibrator roller (IT): 0.0075 cm.
Ink fountain width (IFW): 145 cm.

The ink duct roller speed is for all experiments the same.

The required volume of reference spot colour 1 to achieve an accurate ink saturation so as to achieve the colour target is calculated according to:

$${V}_{1} = F \cdot {SM}_{1} = 8.89 {m}^{2} \cdot 0.9 g / {m}^{2} = 8.001 g .$$

The amount of reference spot colour 1, which is transferred during one ink duct roller and vibrator roller contact (IA) is calculated according to: IA=CL·IT·IFW·

$${ρ}_{1} = 4.2 cm \cdot 0.0075 cm \cdot 145 cm \cdot 1.009 g / {cm}^{3} = 4.608 g .$$

Thus, the number of vibrator roller contacts to the ink duct roller being required to ink the whole area to be inked is V₁/IA=8.001 g/4.608 g=1.7361, being rounded 2.
Reference spot colour 2: VG00032589 Pantone 2411C MGA Natura, of the company hubergroup Deutschland GmbH, Celle, Germany.
Specific ink coverage of reference spot colour 2 (SM₂): 1.4 g/m²
Density (ρ₂) of reference spot colour 2: 1.08 g/cm³.
Contact length (CL) between the duct roller and the vibrator roller: 4.2 cm.
Ink film thickness on the vibrator roller (IT): 0.0075 cm.
Ink fountain width (IFW): 145 cm.

The required volume of reference spot colour 2 to achieve an accurate ink saturation so as to achieve the colour target is calculated according to:

V₂=F·SM₂=8.89 m²·1.4 g/m²=12.446 g.

The amount of reference spot colour 2, which is transferred during one ink duct roller and vibrator roller contact (IA) is calculated according to:

$$IA = CL \cdot IT \cdot IFW \cdot {ρ}_{2} = 4.2 cm \cdot 0.0075 cm \cdot 145 cm \cdot 1.08 g / {cm}^{3} = 4.9329 g .$$

Thus, the number of vibrator roller contacts to the ink duct roller being required to ink the whole area to be inked is V₂/IA=12.446/4.9329 g=2.5231, being rounded 3.
Reference spot colour 3: VG00069398, Pantone 391C MGA Natura, of the company hubergroup Deutschland GmbH, Celle, Germany.
Specific ink coverage of reference spot colour 3 (SM₁): 1.8 g/m² Density (ρ₃) of reference spot colour 3: 1.074 g/cm³.
Contact length (CL) between the duct roller and the vibrator roller: 4.2 cm.
Ink film thickness on the vibrator roller (IT): 0.0075 cm.
Ink fountain width (IFW): 145 cm.

The required volume of reference spot colour 3 to achieve an accurate ink saturation so as to achieve the colour target is calculated according to:

$${V}_{3} = F \cdot {SM}_{3} = 8.89 {m}^{2} \cdot 1.8 g / {m}^{2} = 16.002 g .$$

The amount of reference spot colour 3, which is transferred during one ink duct roller and vibrator roller contact (IA) is calculated according to:

$$IA = CL \cdot IT \cdot IFW \cdot {ρ}_{3} = 4.2 cm \cdot 0.0075 cm \cdot 145 cm \cdot 1.074 g / {cm}^{3} = 4.9055 g .$$

Thus, the number of vibrator roller contacts to the ink duct roller being required to ink the whole area to be inked is V₃/IA=16.002 g/4.9055 g=3.2621, being rounded 3.

Since the ink transfer between the individual rollers in the inking unit is usually not the theoretical possible, but in practice less, correction factors were determined by measuring the number of vibrator roller contacts to the ink duct roller being required to ink the whole area to be inked by printing the reference spot colours 1 onto the substrate. More specifically, a pre-inking of the printing unit of the above-mentioned printing press onto the above-mentioned substrate has been performed in three separate sets of experiments with each of the reference spot colours 1 to 3 using the above-mentioned contact lengths, ink film thickness on the vibrator roller and other parameters. Each set of experiments was started with a number of vibrator roller contacts to the ink duct roller of 22 and after the pre-inking the obtained specific ink coverage of the respective reference spot colour on the substrate has been measured indirectly by measuring the colour strength. With a number of vibrator roller contacts to the ink duct roller of 22, the obtained specific ink coverage was too high and thus in further printings for both of the reference spot colours the number of vibrator roller contacts to the ink duct roller have been reduced so long until the predetermined, above mentioned specific ink coverage by achieving the desired colour strength was obtained, namely 0.9 g/m² for reference spot colour 1, 1.4 g/m² for reference spot colour 2 and 1.8 g/m² for reference spot colour 3. Thereby, the following numbers of vibrator roller contacts to the ink duct roller were obtained, which were significantly higher than the above calculated numbers:

| | Reference | Reference | Reference |
|---|---|---|---|
| Printing ink | Spot Colour 1 | Spot Colour 2 | Spot Colour 3 |
| Ductor vibrator roller | 8 | 14 | 18 |
| contacts from printing | | | |
| experiment | | | |
| Ductor vibrator roller | 1.7361 | 2.5231 | 3.2621 |
| contacts, calculated | | | |

Considering these numeric values, the polynomial trend line of order 2 shown in FIG. 2 has been determined of the numbers of vibrator roller contacts to the ink duct roller of each of the reference spot colours 1 to 3 having been determined in the respective printing experiments versus the calculated numbers of vibrator roller contacts to the ink duct roller of each of the reference spot colours 1 to 3. In other words, the ordinate of the diagram of FIG. 2 shows the numbers of vibrator roller contacts to the ink duct roller of each of the reference spot colours 1 to 3 having been determined in the respective printing experiments, whereas the abscissa shows the calculated numbers of vibrator roller contacts to the ink duct roller of each of the reference spot colours 1 to 3. The formula of the polynomial trend line is:

$$Y = - 1.4493 \cdot {x}^{2} + 13.797 \cdot x - 11.585 .$$

Using this polynomial trend line, the number of vibrator roller contacts to the ink duct roller being necessary to obtain, by printing the predetermined spot colour of example 3 with the predetermined printing unit onto the predetermined substrate, the specific ink coverage having been predetermined is determined as follows:
Spot colour of example 3: VG00073407 Pantone 2186C, MGA Natura, of the company hubergroup Deutschland GmbH, Celle, Germany.
Specific ink coverage of the spot colour of example 3 (SM): 1.2 g/m²
Density (φ of the spot colour of example 3: 1.08 g/cm³.
Contact length (CL) between the duct roller and the vibrator roller: 4.2 cm.
Ink film thickness on the vibrator roller (IT): 0.0075 cm.
Ink fountain width (IFW): 145 cm.

The required volume of the spot colour of example 3 to achieve an accurate ink saturation so as to achieve the colour target is calculated according to:

$$V = F \cdot SM = 8.89 {m}^{2} \cdot 1.2 g / {m}^{2} = 10.668 g .$$

The amount of the spot colour of example 3, which is transferred during one ink duct roller and vibrator roller contact is calculated according to: IA=CL·IT·IFW

$$ρ = 4.2 cm \cdot 0.0075 cm \cdot 145 cm \cdot 1.08 g / {cm}^{3} = 4.9329 g .$$

Thus, the calculated number of vibrator roller contacts to the ink duct roller being required to ink the whole area to be inked is V₁/IA=10.668 g/4.9329 g=2.1626.

Considering the above polynomial trend line, the actual number of vibrator roller considering the correction factor is:

$$Y = - 1.4493 \cdot {( 2.1418 )}^{2} + 13.797 \cdot 2.1418 - 11.585 = 11.32 ,$$

$$being rounded 11.$$

Thereby, the number of vibrator roller contacts to the ink duct roller being necessary to obtain, by printing the spot colour of example 3 as well as of any other spot colour can be reliably obtained without necessity of printing the respective spot colour of example 1 onto the substrate by simply using the aforementioned polynomial trend line, which needs to be only generated once with a set of reference spot colours.

### REFERENCE NUMERALS

10 Printing unit
12 Plate cylinder
14 Blanket cylinder
16 Impression cylinder
18 Substrate to be printed with the spot colour
20 Ink fountain
22 Ink duct roller
24 Vibrator roller
26, 26′, 26″ Friction cylinders
28, 28′, 28″ Friction rollers
30, 30′, 30′ Weight rollers
32, 32′, 32″ Friction cylinders
34, 34′, 34″, 34′″, 34^{iv} Colour application rollers
36 Fountain bridge roller
38 Fountain application roller
40 Transfer roller
42 Fountain dosing roller
44 Rider roller
46 Arrow

1. A method for calculating the parameters for the pre-inking of a printing unit (10) of an offset printing press with a spot colour comprising the following steps:
a) predetermining a printing unit (10), a spot colour, a substrate (18) to be printed with the spot colour and a specific ink coverage necessary to achieve predetermined colour coordinates of the spot colour to be achieved on the substrate (18),
b) determining the number of vibrator roller contacts to the ink duct roller (22) being necessary to obtain, by printing the predetermined spot colour with the predetermined printing unit (10) onto the predetermined substrate (18), the specific ink coverage having been predetermined in step a) from at least two different reference spot colours, wherein each of the at least two different reference spot colours has been printed with the printing unit (10) having been predetermined in step a) onto the substrate (18) having been predetermined in step a) with a different predetermined specific ink coverage.

2. The method in accordance with claim 1, wherein in step b) a difference between the predetermined specific ink coverage of one of the at least two different reference spot colours on the substrate (18) and the predetermined specific ink coverage of another one of the at least two different reference spot colours on the substrate (18) is at least 0.3 g/m², preferably at least 0.5 g/m², more preferably at least 0.7 g/m², even more preferably at least 0.8 g/m², still more preferably at least 1.0 g/m² and most preferably at least 1.2 g/m² of the substrate (18).

3. The method in accordance with claim 1, wherein in step b) two to ten, preferably two to five, more preferably two to four, still more preferably two or three and most preferably two different reference spot colours are used.

4. The method in accordance with claim 1, wherein all reference spot colours used in step b) have the same colour coordinates.

5. The method in accordance with claim 1, wherein the printing unit (10) predetermined in step a) comprises an inking unit, a fountain unit, a plate cylinder (12), a blanket cylinder (14) and an impression cylinder (16), wherein the inking unit preferably comprises an ink fountain (20), a vibrator roller (24), an ink duct roller (22) and one or more ink rollers.

6. The method in accordance with claim 5, wherein the determination in step b) of the number of vibrator roller contacts to the ink duct roller (22) being necessary to obtain, by printing the predetermined spot colour with the predetermined printing unit (10) onto the predetermined substrate (18), the specific ink coverage having been predetermined in step a) comprises for each of the at least two different reference spot colours the consideration of:
a) the total area to be inked of all rollers in the inking unit optionally together with the area of the dampening rollers, if a dampening unit is connected during the pre-inking to the inking unit,
b) the ink duct roller (22) speed,
c) the number of vibrator roller contacts to the ink duct roller (22) and
d) the gap of the ink key opening of the ink fountain (20).

7. The method in accordance with claim 5, wherein the number of vibrator roller contacts to the ink duct roller (22) being necessary to obtain, by printing the spot colour with the printing unit (10) onto the substrate (18), the specific ink coverage having been predetermined in step a) is determined in step b) from at least two different reference spot colours and preferably from two different reference spot colours each of which having been printed with the printing unit (10) having been predetermined in step a) onto the substrate (18) having been predetermined in step a) with a different predetermined specific ink coverage, with the same predetermined ink duct roller (22) speed and with the same predetermined ink key opening of the ink fountain (20).

8. The method in accordance with claim 5, which comprises:
i) before printing the at least two different reference spot colours with the printing unit (10) having been predetermined in step a) onto the substrate (18) having been predetermined in step a), predetermining for each of the at least two different reference spot colours an ink coverage being necessary to achieve a predetermined specific ink coverage to be achieved by the printing, a gap of the ink key opening of the ink fountain (20) of the printing unit (10) to be adjusted during the printing and an ink duct roller (22) speed to be adjusted during the printing, wherein the specific ink coverages predetermined for each of the at least two different reference spot colours are different to each other,
ii) printing each of the at least two different reference spot colours with the predetermined ink coverage, with the predetermined gap of the ink key opening of the ink fountain (20) of the printing unit (10), with the predetermined ink duct roller (22) speed and with an arbitrarily selected number of vibrator roller contacts to the ink duct roller (22) with the printing unit (10) having been predetermined in step a) onto the substrate (18) having been predetermined in step a),
iii) determining, whether the predetermined specific ink coverage has been achieved on the substrate (18) or not, wherein, if the predetermined specific ink coverage has been achieved on the substrate (18), the arbitrarily selected number of vibrator roller contacts to the ink duct roller (22) is saved as the appropriate number of vibrator roller contacts to the ink duct roller (22) for the respective reference spot colour, and, if the predetermined specific ink coverage has not been achieved on the substrate (18), step ii) is repeated for the concerned reference spot colour with one or more other arbitrarily selected numbers of vibrator roller contacts to the ink duct roller (22) so often, until the predetermined specific ink coverage is achieved on the substrate (18), wherein the numbers of vibrator roller contact being for achieving the predetermined specific ink coverage on the substrate (18) is saved as the appropriate number of vibrator roller contacts to the ink duct roller (22), and
iv) calculating from the appropriate numbers of vibrator roller contacts to the ink duct roller (22), the predetermined ink coverages, the predetermined gaps for the ink key opening of the ink fountain (20) and the predetermined ink duct roller (22) speeds of each of the at least two reference spot colours the number of vibrator roller contacts to the ink duct roller (22) to be used in step b).

9. The method in accordance with claim 8, wherein in step i) the ink coverage for each of the reference spot colours is calculated as product of the total area to be inked of all rollers in the inking unit optionally together with the area of the dampening rollers, if a dampening unit is connected during the pre-inking to the inking unit, and of the predetermined specific ink coverage of the reference spot colour to be achieved on the substrate (18) being necessary to obtain, by printing the predetermined spot colour with the predetermined printing unit (10) onto the predetermined substrate (18), the specific ink coverage having been predetermined in step a).

10. The method in accordance with claim 8, wherein for each of the reference spot colours a coefficient is calculated according to the following formula (1): 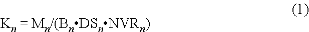
wherein:
K means coefficient,
n is an integer representing the number of the reference spot colour concerned,
M is the amount of the spot colour ink in grams required for inking the total area to be inked of all rollers in the inking unit optionally together with the area of the dampening rollers, if the dampening unit is connected during the pre-inking process to the ink unit, representing the specific grammage per square meter for the respective reference colour,
B is the gap of the ink key opening of the ink fountain (20) used during the pre-inking process of the respective reference spot colour,
DS is the ink duct roller (22) speed used during the pre-inking process of the respective reference spot colour and
NVR is the number of vibrator roller contacts to the ink duct roller (22).

11. The method in accordance with claim 10, further comprising:
calculating the ink coverage of the spot colour being necessary to achieve the specific ink coverage being in turn necessary to achieve the colour coordinates of the spot colour on the substrate (18) having been predetermined in step a) as product of the total area to be inked of all rollers in the inking unit optionally together with the area of the dampening rollers, if a dampening unit is connected during the pre-inking to the inking unit, and of the predetermined specific ink coverage to be achieved on the substrate (18),
predetermining the ink duct roller (22) speed used during the pre-inking process of the spot colour and
predetermining the gap of the ink key opening of the ink fountain (20) used during the pre-inking process of the spot colour,
wherein the number of vibrator roller contacts to the ink duct roller (22) being necessary to obtain, by printing the predetermined spot colour with the predetermined printing unit (10) onto the predetermined substrate (18), the specific ink coverage having been predetermined in step a) is calculated from the predetermined ink coverage preferably using small scale laboratory printing machines for printing and measuring the applied amount of ink, the predetermined ink duct roller (22) speed, the predetermined gap of the ink key opening of the ink fountain (20) and the coefficients K₁ of the at least two reference spot colours.

12. The method in accordance with claim 11, in which two reference spot colours are used, and, wherein the method further comprises:
v) calculating for the spot colour predetermined in step a) a coefficient K according to the formula (2): 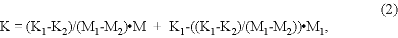
in which:
K is the coefficient to be calculated for the spot colour predetermined in step a),
K₁ is the coefficient having been calculated according to formula (1) for a first of the two reference spot colours,
K₂ is the coefficient having been calculated according to formula (1) for the second of the two reference spot colours,
M is the amount of the spot colour ink predetermined in step a) in grams required for inking the total area to be inked of all rollers in the inking unit optionally together with the area of the dampening rollers, if a dampening unit is connected during the pre-inking process to the rollers of the ink unit,
M₁ is the amount of the first reference spot colour ink in grams required for inking the total area to be inked of all rollers in the inking unit optionally together with the area of the dampening rollers, if a dampening unit is connected during the pre-inking process to the rollers of the ink unit and
M₂ is the amount of the second reference spot colour ink in grams required for inking the total area to be inked of all rollers in the inking unit optionally together with the area of the dampening rollers, if a dampening unit is connected during the pre-inking process to the rollers of the ink unit,
and
vi) calculating the number of vibrator roller contacts to the ink duct roller (22) being necessary to obtain for the spot colour predetermined in step a) the specified colour coordinates by printing the spot colour with the inking unit onto the substrate (18) in the specific ink coverage having been predetermined in step a) according to the formula (3): 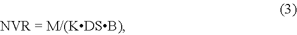
wherein:
NVR is the number of vibrator roller contacts to the ink duct roller (22) being necessary to obtain for the spot colour predetermined in step a) the specified colour coordinates by printing the spot colour with the inking unit onto the substrate (18) in the specific ink coverage having been predetermined in step a),
M is as defined above with regard to formula (2),
K is the coefficient having been calculated in step v) with formula (2),
DS is the ink duct roller (22) speed in m/minute and
B is the gap of the ink key opening of the ink fountain (20) used during the pre-inking process of the spot colour.

13. The method in accordance with claim 8, wherein a polynomial trend line of the specific ink coverage of each of the reference spot colours versus the appropriate number of vibrator roller contacts to the ink duct roller (22) of each of the reference spot colours having been determined in step iii) is determined, wherein the number of vibrator roller contacts to the ink duct roller (22) being necessary to obtain, by printing the predetermined spot colour with the predetermined printing unit (10) onto the predetermined substrate (18), the specific ink coverage having been predetermined in step a) is determined from the polynomial trend line.

14. The method in accordance with claim 13, wherein the polynomial trend line is of order 2 to 5 and preferably of order 2 to 4, wherein preferably the polynomial trend line is determined by using the method of least squares.

15. The method in accordance with claim 13, wherein three to twenty, preferably five to twenty and more preferably eight to twelve reference spot colours are used for determining the polynomial trend line, wherein preferably the predetermined specific ink coverages of all reference spot colours cover at least a numeric value range of 1.2 to 1.6 g/m², more preferably of 1.0 to 1.8 g/m² and most preferably of 0.8 to 2.0 g/m².

16. The method in accordance with claim 5, wherein the determination in step b) of the number of vibrator roller contacts to the ink duct roller (22) being necessary to obtain, by printing the predetermined spot colour with the predetermined printing unit (10) onto the predetermined substrate (18), the specific ink coverage having been predetermined in step a) comprises for each of the at least two different reference spot colours the consideration of:
a) the total area to be inked of all rollers in the inking unit optionally together with the area of the dampening rollers, if a dampening unit is connected during the pre-inking to the inking unit,
b) the ink film thickness on the vibrator roller,
c) the contact length between the duct roller (22) and the vibrator roller,
d) the physical density of the spot colour and
d) the ink fountain width.

17. The method in accordance with claim 16, wherein the number of vibrator roller contacts to the ink duct roller (22) being necessary to obtain, by printing the spot colour with the printing unit (10) onto the substrate (18), the specific ink coverage having been predetermined in step a) is determined in step b) from at least two different reference spot colours and preferably from at least three different reference spot colours each of which having been printed with the printing unit (10) having been predetermined in step a) onto the substrate (18) having been predetermined in step a) i) with a different predetermined specific ink coverage and ii) with a different or preferably the same predetermined ink film thickness on the vibrator roller and/or iii) with a different or preferably the same predetermined contact length between the duct roller (22) and the vibrator roller and/or iii) with a different or preferably the same predetermined ink fountain width.

18. The method in accordance with claim 16, which comprises:
i) before printing the at least two different reference spot colours with the printing unit (10) having been predetermined in step a) onto the substrate (18) having been predetermined in step a), predetermining for each of the at least two different reference spot colours an ink coverage being necessary to achieve a predetermined specific ink coverage to be achieved by the printing, a contact length between the duct roller (22) and the vibrator roller to be adjusted during the printing, an ink film thickness on the vibrator roller to be adjusted during the printing and an ink fountain width to be adjusted during the printing, wherein the specific ink coverages predetermined for each of the at least two different reference spot colours are different to each other,
ii) calculating for each of the at least two different reference spot colours the number of vibrator roller contacts to the ink duct roller (22) being required to ink the whole area of the printing unit (10),
iii) printing each of the at least two different reference spot colours with the predetermined ink coverage, with the predetermined contact length between the duct roller (22) and the vibrator roller, with the predetermined ink film thickness on the vibrator roller, with the predetermined ink fountain width and with an arbitrarily selected number of vibrator roller contacts to the ink duct roller (22) with the printing unit (10) having been predetermined in step a) onto the substrate (18) having been predetermined in step a),
iv) determining, whether the predetermined specific ink coverage has been achieved on the substrate (18) or not, wherein, if the predetermined specific ink coverage has been achieved on the substrate (18), the arbitrarily selected number of vibrator roller contacts to the ink duct roller (22) is saved as the appropriate number of vibrator roller contacts to the ink duct roller (22) for the respective reference spot colour, and, if the predetermined specific ink coverage has not been achieved on the substrate (18), step ii) is repeated for the concerned reference spot colour with one or more other arbitrarily selected numbers of vibrator roller contacts to the ink duct roller (22) so often, until the predetermined specific ink coverage is achieved on the substrate (18), wherein the numbers of vibrator roller contact being for achieving the predetermined specific ink coverage on the substrate (18) is saved as the appropriate number of vibrator roller contacts to the ink duct roller (22),
v) determining a polynomial trend line of the appropriate number of vibrator roller contacts to the ink duct roller (22) having been determined in step iv) for the at least two different reference spot colours versus the number of vibrator roller contacts to the ink duct roller (22) having been calculated in step ii) preferably by using the method of least squares, and
vi) calculating for the spot colour having been predetermined in step a) the number of vibrator roller contacts to the ink duct roller (22) being required to ink the whole area of the printing unit (10) and calculating therefrom using the polynomial trend line having been predetermined in step v) the number of vibrator roller contacts to the ink duct roller (22) being necessary to obtain, by printing the predetermined spot colour with the predetermined printing unit (10) onto the predetermined substrate (18), the specific ink coverage having been predetermined in step a).
